(19) United States
(12) Patent Application Publication
(10) Pub. No.: US 2016/0309444 A1
(43) Pub. Date: Oct. 20, 2016

(54) COMPLIANCE TEST MONITOR AND NOTIFICATION

(71) Applicant: CARPE VERITAS, LLC, FARMINGTON HILLS, MI (US)

(72) Inventors: JON SRIRO, HUNTINGTON WOODS, MI (US); TODD KALUZNY, TROY, MI (US); ERIK LAZAR, BLOOMFIELD HILLS, MI (US)

(21) Appl. No.: 15/098,659

(22) Filed: Apr. 14, 2016

Related U.S. Application Data
(60) Provisional application No. 62/147,343, filed on Apr. 14, 2015.

(51) Int. Cl. H04W 68/00; H04M 1/725; H04W 4/02

(52) U.S. Cl. CPC H04W 68/00; H04W 4/025; H04M 1/72563

(57) ABSTRACT

A system and method is provided for compliance noon monitoring with an automated application to remind and monitor for compliance testing and reporting. Users of the notification platform, do not have to remember an event, the calendar system of the platform automatically updates itself and remembers an event for the user. The notification platform introduces a new method for handling personally identifiable and confidential information of an end user that allows end users to avoid transmission of confidential data to a third-party for the purpose of a third-party manually adding reminders and events, since all personally identifiable and confidential information is stored and managed on an end user's device. The notifications and events are scheduled by third-parties remotely. The third-parties do not need to be on the same computer network as the end user or have any information concerning the end user.

### CROSS REFERENCE TO RELATED APPLICATIONS

This application claims priority benefit of U.S. Provisional Application Ser. No. 62/147,343 filed 14 Apr. 2015; the contents of which are hereby incorporated by reference.

### FIELD OF THE INVENTION

The present invention in general relates to compliance monitoring and an automated application to remind and monitor for compliance testing and reporting.

### BACKGROUND OF THE INVENTION

Individuals who are on court ordered probation for drug or alcohol related convictions are generally subjected to court ordered monitoring and random substance abuse testing.

A person on probation or on parole is ordered to take random drug and alcohol tests on a random test day. Currently, those on probation or on parole are obligated and required to call their assigned testing center or court each morning to find out of it is their day to test. If a probationer or parolee fails to remember to call the testing center or court on a particular day or misses their time slot for testing, the courts consider the probationer or parolee to have failed the test. Thus, the court generally considers a missed drug or alcohol test as a positive test, even if the person under probation or on parole is not currently using a prohibited substance that would violate the terms of their probation or parole. Therefore, persons on probation or parole find it vitally important to remember to call their testing center every morning, at least twice in some instances, to make absolutely sure their color has been actually called. Just thinking about the possibility of making a mistake in their court ordered testing or reporting is a source of great stress and concern.

The calendaring of events is essentially the same now as it has been over the last several hundred years. A user must manually mark down an appointment or event they want to attend or remember. There are currently paper calendars, At-A-Glance calendars, and digitally recorded events with computer calendaring programs.

However, these calendaring solutions still require the manual input of events and reminders, which still put the responsibility of remembering to record an event on the user. Thus there exists a need for improved systems and methods for compliance monitoring, testing and reporting.

### SUMMARY OF THE INVENTION

A non-transitory computer-readable medium for implementing an automated. compliance monitoring application to remind and monitor for compliance testing and reporting is provided that includes instructions stored thereon, that when executed on a processor provides an application (app) for an end user device with a graphical user interface (GUI) from a platform. Information about the end user and the end user's geographic location are received via the graphical user interface (GUI) from the user. The end user's selection of one of a testing center or reporting location is received from the end user, and the end user is verified based on the received information Notifications are sent to the end user, and personally identifiable and confidential information of the end user is stored on the end user device and is not transmitted to a third-party that generates the notifications.

A method for implementing an automated compliance monitoring application to remind and monitor for compliance testing and reporting is provided that includes providing an application (app) for an end user device with a graphical user interface (GUI) from a platform. Information about the end user and the end user's geographic location are received via the graphical user interface (GUI) from the user. The end user's selection of one of a testing center or reporting location is received from the end user, and the end user is verified based on the received information. Notifications are sent to the end user, and personally identifiable and confidential information of the end user is stored on the end user device and is not transmitted to a third-party that generates the notifications.

A system for implementing an automated compliance monitoring application to remind and monitor for compliance testing and reporting, the system includes a server connected via a network to end user devices for use by a series of end users, and a memory system in electrical communication with the server containing a machine readable medium having stored thereon one or more sequences of instructions which, when executed by a processor, cause a method to be carried out. The method includes providing an application (app) for an end user device with a graphical user interface (GUI) from a platform. Information about the end user and the end user's geographic location are received via the graphical user interface (GUI) from the user. The end user's selection of one of a testing center or reporting location is received from the end user, and the end user is verified based on the received information. Notifications are sent to the end user, and personally identifiable and confidential information of the end user is stored on the end user device and is not transmitted to a third-party that generates the notifications.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A and 1B is a flow diagram of the process elements in accordance with embodiments of the invention; and

FIG. 2 is a schematic diagram illustrating an overall view of communication devices, computing devices, and mediums for implementing embodiments of the invention.

The detailed description explains the preferred embodiments of the invention.

### DESCRIPTION OF THE INVENTION

The present invention has utility as a system and method for compliance monitoring with an automated application to remind and monitor for compliance testing and reporting. With embodiments of the inventive calendar notification platform, users do not have to remember an event, the calendar system of the platform automatically updates itself and remembers an event for the user. Embodiments of the inventive calendar notification platform introduce a new means of handling personally identifiable and confidential information of an end user that allows end users to avoid transmission of confidential data to a third-party for the purpose of a third-party manually adding reminders and events, since all personally identifiable and confidential information is stored and managed on a user's computing or smartphone device. The inventive calendar notification platform sends aggregate data to the end user's device, and a software application (app) on the end user's device deciphers the information and processes the information relevant to the end user. The notifications and events are scheduled by third-parties remotely. The third-parties do not need to be on the same computer network as the end user or have any information concerning the end user. Embodiments of the app are configured as a downloadable application (app) that are available for computing operating systems (OS) or mobile operating systems illustratively including Windows, OS X, Linux, Android, iOS, Windows for mobile, and other available mobile operating systems (OS).

The result is a highly effective calendar notification platform (“Calendication”) that proactively alerts end users of events relevant to the end user and automatically schedules those events and reminders on the end user's device. Thus, the inventive calendar notification platform solves the problems inherent in the current method and modes for calendars—data entry. A calendar is only as good as the person entering the data—embodiments of the inventive platform take the data entry component out of the equation. Embodiments of the inventive calendar notification platform also allow for the scheduling and notification of random events that are set by third-parties on the fly on the end user's calendar without the end user sharing any personally identifiable information with the third-party. Specific embodiments of the inventive calendar notification platform also have a built in archiving functionality that stores test verification data, so that users may document their testing history to their probation officer. In addition, a log may be created with each notification that the end user receives relevant to the testing groups chosen by the end user. The log is evidence of whether or not the end user actually received notification of an event. This log is stored on the end user's computing device or smart phone and cannot be altered; the log may only be viewed. The log may be maintained for a 90 day period and can be saved and archived if the end user so chooses.

While several steps performed by an inventive process and anon-transitory system involve one or more abstract ideas, the present invention as a whole includes aspects that amount to significantly more than the abstract idea. Indeed, aspects of the present invention have never been previously performed in manual or digital form prior to the present invention. As recitations of using a non-transitory computer medium to perform compliance monitoring with an automated application to remind and monitor for compliance testing and reporting. With embodiments of the inventive calendar notification platform, users do not have to remember an event, the calendar system of the platform automatically updates itself and remembers an event for the user. The calendar notification platform introduces anew means of handling personally identifiable and confidential information of an end user that allows end users to avoid transmission of confidential data to a third-party for the purpose of a third-party manually adding reminders and events, since all personally identifiable and confidential information is stored and managed on a user's computing or smartphone device. The inventive calendar notification platform sends aggregate data to the end user's device, and a software application (app) on the end user's device deciphers the information and processes the information relevant to the end user. These aspects of the present invention as a calendar notification platform, amount to significantly more than simply providing a calendar by addressing the challenges of current calendar programs—data entry. A calendar is only as good as the person entering the data embodiments of the inventive platform take the data entry component out of the equation. As a result, the present invention provides a highly effective calendar notification platform (“Calendication”) that proactively alerts end users of events relevant to the end user and automatically schedules those events and reminders on the end user's device. Thus, the inventive calendar notification platform solves the problems inherent in the current method and modes for calendars—data entry. The present invention has the effect of improving compliance monitoring with an automated application to remind and monitor for compliance testing and reporting.

The invention recites a series of acts for implementing an automated compliance monitoring application (app) on an end user device to remind and monitor for compliance testing and reporting comprising instructions stored thereon, that are executed on a processor.

The invention relates to software technology that implements an app on an end user device with a graphical user interface (GUI) from a platform, where the platform receives information about the end user and the end user's geographic location via a graphical user interface (GUI) from a user, and receives the end user's selection of one of a testing center or reporting location. The platform and verifies the end user based on the received information, sends notifications to the end user. Furthermore, personally identifiable and confidential information of the end user is stored on the end user device and is not transmitted to a third-party that generates the notifications. Such action does not describe an abstract concept, or a concept similar to those found by the courts to be abstract, such as a fundamental economic practice, a method of organizing human activity, an idea itself (standing alone) or a mathematical relationship. In contrast, the invention claimed here is directed towards relates to software technology that implements an app on an end user device with a graphical user interface (GUI) from a platform that perform compliance monitoring with an automated application to remind and monitor for compliance testing and reporting, a concept inextricably tied to computer technology and distinct from the types of concepts found by the courts to be abstract. Accordingly, the inventive steps do not recite an abstract idea nor do they implicate any other judicial exception.

In addition, the claimed invention is also directed to a non-transitory computer-readable medium, which is a manufacture, and thus a statutory category of invention.

Embodiments of the inventive calendar notification platform may be used in many diverse applications and settings including the following non-limiting illustrative examples:

1. Coordination of random drug testing for employees in both the private and public sectors.
2. Coordination of scheduling in both private and public sectors, e.g., on call type employees, employees that work shifts, etc.
3. Communication by the courts with probationers in lieu of mail, e.g., a court can avoid sending out notices by mail and instead communicate with probationers and schedule events on the probationer's device with notifications.
4. Mandatory appointments may be set on devices of individuals that are outside or inside the scheduler's computer network.

In a specific embodiments of the software application (app) of the inventive calendar notification platform that are resident on an end user's device (e.g., computer, mobile computer, tablet, Ipad, smart phone, smartTV, smart watch), the app notifies the end user exactly when they have to test for court ordered or other mandatory drug and alcohol testing without the necessity of having to call into the testing center every morning or the tester calling or emailing the test taker. Notifications may include voice notification of an event, a reminder in multiple languages, or tactile reminders through vibration. The inventive app also ensures that end users will not miss their tests by forgetting to call or by not hearing the phone recording correctly. Embodiments of the app allow end users to input 1 or 2 different color group designations for both breath and urine testing. The app also allows the end user to input a special court group of which they may also be a member. These testing groups may be created in real time by the tester through a web based administrator panel. Third-parties affiliated with the app. illustratively including drug testing centers, may set the time and date of a test in a separate web based admin section, which will notify the end user of the testing or other event through a push notification. End users using the app may check in to the testing center utilizing the technology of iPhone's Apple Pay® technology, or Android Google Pay® and Wallet®.

Embodiments of the inventive app allow an end user to obtain and send proof of the fact they have, in fact, taken their test. The proof may be done in the form of a photo function, whereby end users may take a time and date stamped photo of their receipt, which is saved to the photo gallery in the app. End users may also send proof of their having taken the test to another individual, such as a court, probation officer, or other person for verification purposes. Embodiments of the app may also have a geo-location tag, which further proves that the end user was at the testing facility on the date and time of their test. In specific embodiments, an alphanumeric code, which may be in the form of a scan code illustratively including a barcode or a QR code, that end users will be able to scan, which would prove that they took their test. Embodiments of the inventive calendar notification platform randomly generate a new QR code every day for the testing facilities.

In specific embodiments, the web based admin section automatically communicates directly with the end user, e.g., the individual on probation, and generates a pass/fail QR code for that end user, which the end user may scan with their smart phone and automatically transmit the results to anyone, including their probation officer. The web based admin section may automatically generate a QR code for the test center each day there is a test and the end user/test taker will be able to photograph or scan the QR Code on their smart phone. In a specific embodiment the QR Code may have the following information: name of end user, time and location of end user at the time of the creation of the QR code, the test results for the tests. Kiosks may be used to allow remote transmission of QR. codes to testing centers for testing verification by the end user.

Embodiments of the app may have the functionality to be connected to other devices wirelessly or through an adapter for purposes of conducting self-testing. For instance, fingerprint drug testing, and blow testing.

Embodiments of the inventive app are configured to allow an end user to select custom notification text messages to alert them when to test. This will help the end user to avoid embarrassment, if somebody should see their phone or other notifying device. Notifications may also include voice notification of an event or reminder in multiple languages, tactile reminders through vibration Embodiments of the app may also have an alarm feature, which will allow the end user to set a reminder alarm for a later time for when to test. Furthermore, in specific embodiments if an end user is scheduled for a test, the end user may have the option to set the app to send a message back to the platform which will trigger an automated call to the end user reminding the end user to take the test on the test day.

Embodiments of the app may also work with locating features (global positioning satellites (GPS), cellular system triangulation, internet protocol address (IP)) to locate the closest testing site with respect to the end user's current location. The inventive app will also provide the end user with turn by turn directions as well as a contact number for each and every possible testing site or center. The app may also have a tab for strategic advertisers, which may be based on geographic location, and may include advertisements for bail bonds, attorneys, cabs, on-line driver services, and other location sensitive services. Other geo-sensitve applications illustratively including: Hotzone—notifications; pinging when a user arrives at a specified location, based upon geo location; coordinate bracelet tracker with app; and a car tracker—tracking driving behaviors. Embodiments of the app may have a geo location stamp that can be activated by the end user to record where they are and the date and time the end user is at a particular location in order to verify the whereabouts of the end user to the courts or anyone-else seeking verification, An end user may use the geo location and QR. Code scanner to record proof of attendance at required counseling or substance abuse group meetings. Furthermore, the geo locator may allow specified individuals the ability to track the end user in real time, which will enable the app to act as a virtual tether.

Embodiments of the app will not transmit any confidential information about the end user, where the confidential information is stored on the end user's device, and the confidential information is not collected by the platform. Embodiments of the app are configured to allow the end user to edit or change their profile, including their testing color, testing site, or any other profile information at any time.

Security identification features for the end user using the inventive app may illustratively include bio metrics: voice recognition, facial recognition, retinal scan, finger scan in order to check in to a testing center, which will integrate with the admin section for the app that the testing center has access to; this will enable the testing center to have an electronic fail safe means of tracking attendance, The app may use encryption to protect information sent from the app to the court or parole officer or anyone-else the app is set to send information to, thereby, protecting the end user's privacy. The user device may be configured with anti-tamper proof protections.

Embodiments of the web based admin section and the app may be based on a customer relationship management system (“CRM”) that may be utilized for courts, testing centers, and companies. For instance, courts may use the app to notify people of holiday testing; this will save the court money by avoiding the need to send out mailers to probationers that it wants to test on days that the court is not open. Furthermore, the app may be used for sending notifications of testing or anything-else in corporate, parental, government, law enforcement, military, and court pretrial services/community correction facility settings, or any other business platforms.

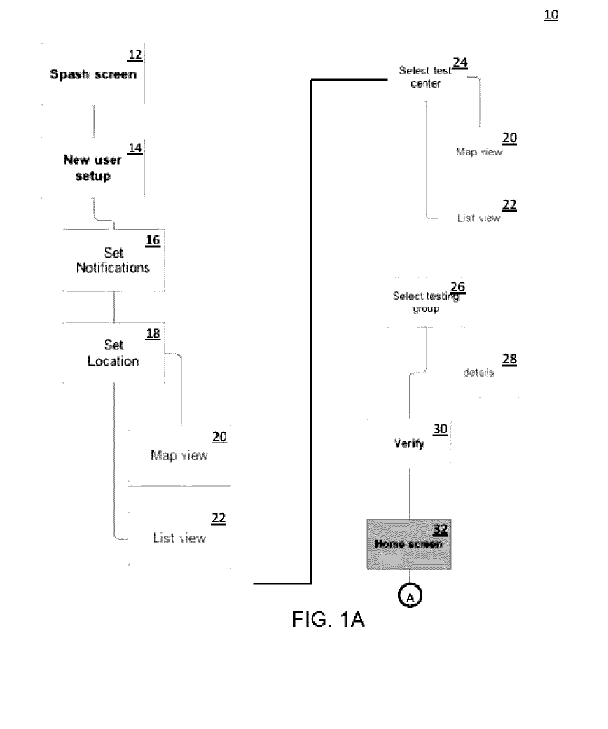

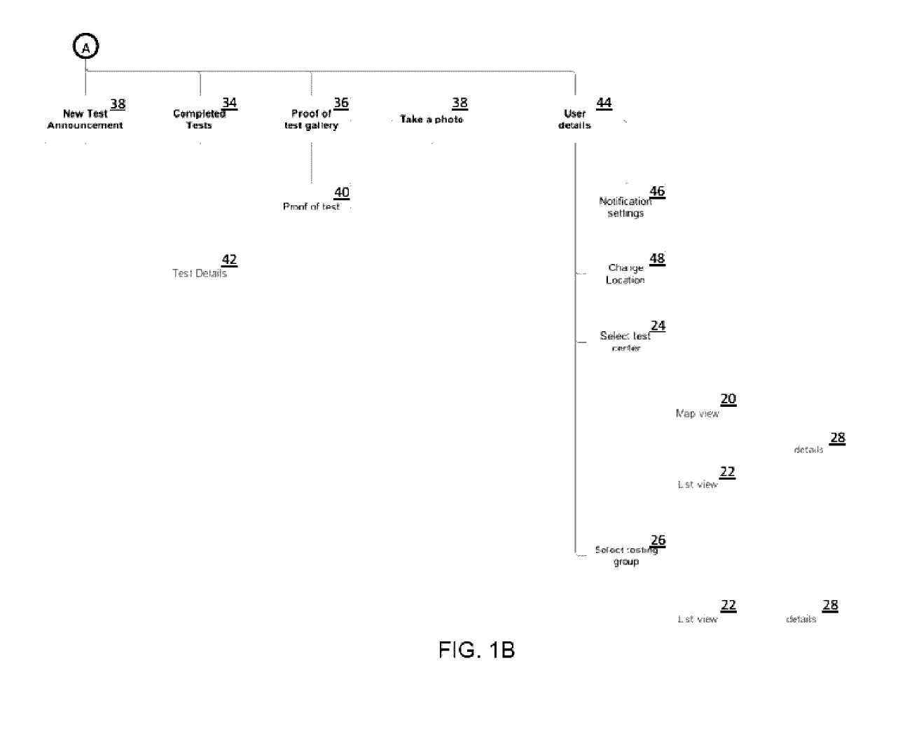

Referring now to the figures, FIGS. 1A and 1B illustrate a flow diagram 10 of the process elements in accordance with embodiments of the invention. The end user is presented with an introductory splash screen (block 12) and a new user setup screen (block 14) that may be used by the end user to set notification preferences (block 16) and sets their location (Block 18) through a map view (block 20) or list view (block 22). The end user may then select a test center (block 24) through a map view (block 20) or list view (block 22), and a testing group (block 26 based in the testing center. Prior to joining a group, the end user is verified (block 30) with their details (block 28). The end user—once verified—is brought back to a home screen (block 32) The user may receive a new test announcement (block 38), store completed tests (block 34) with associated test details (block 42). A proof of test gallery (block 36) may be maintained with photos (block 38) and other proof of test elements (block 40). Also reached from the ho screen (block 32) the end user details (block 44) that may be edited to change notification settings (block 46), location (block 48), test center (block 24) via map view (block 20) and/or list view (block 22) with their associated detail (block 28). A testing group (block 26) may be chosen via list view (block 22) with associated details (block 28),

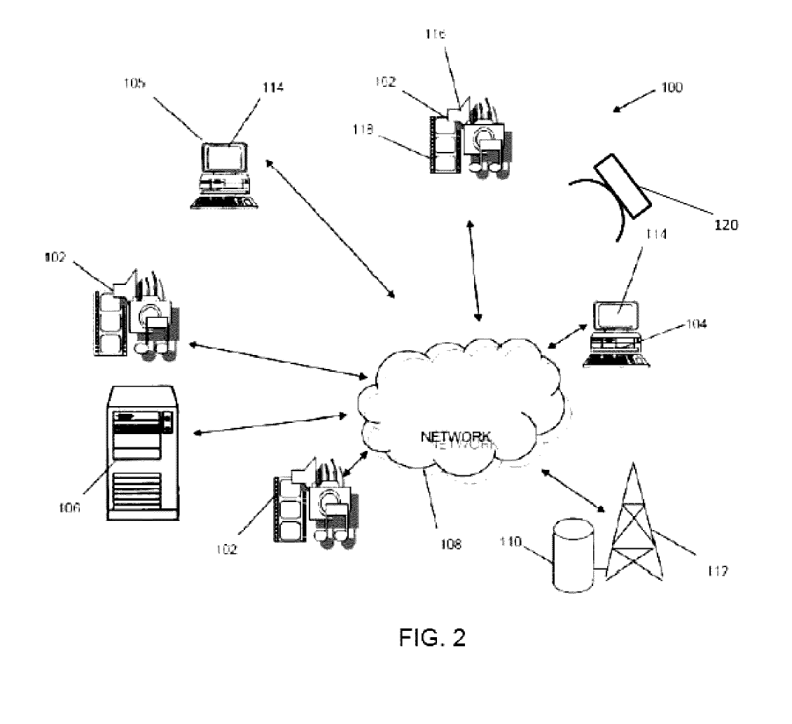

FIG. 2 is a schematic diagram illustrating an overall view of communication devices, computing devices, and mediums for implementing the platform according to embodiments of the invention. The elements of the embodiments of FIGS. 1A and 1B are included in the networks and devices of FIG. 2.

The system 100 includes an end-point device 102 and desktop computer devices 104 configured with display capabilities 114 and processors for executing instructions and commands. The end-point device 102 is in certain embodiments mobile communication and entertainment devices, such as cellular phones, tablets, and mobile computing devices that in certain embodiments are wirelessly connected to a network 108. The end-point device 102 typically has a video displays 118 and audio outputs 116. The end-point device 102 and desktop computer devices 104 are optionally configured with internal storage, software, and a graphical user interface (GUI) for carrying out elements of the platform according to embodiments of the invention. The network 108 is optionally any type of known network including a fixed wire line network, cable and fiber optics, over the air broadcasts, satellite 120, local area network (LAN), wide area network (WAN), global network (e.g., Internet), intranet, etc. with data/Internet capabilities as represented by server 106. Communication aspects of the network are represented by cellular base station 110 and antenna 112. in a preferred embodiment, the network 108 is a LAN and each remote device 102 and desktop device 104 executes a user interface application (e.g., Web browser) to contact the server system 106 through the network 108. Alternatively, the remote devices 102 and 104 may be implemented using a device programmed primarily for accessing network 108 such as a remote client.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A non-transitory computer-readable medium for implementing an automated compliance monitoring application to remind and monitor for compliance testing and reporting comprising instructions stored thereon, that when executed on a processor, perform the steps of:
providing an application (app) for an end user device with a graphical user interface (GUI) from a platform;
receiving information about the end user and the end user's geographic location via said graphical user interface (GUI) from a user;
receiving the end user's selection of one of a testing center or reporting location; and
verifying the end user based on the received information;
sending notifications to the end user; and
wherein personally identifiable and confidential information of the user is stored on the end user device and is not transmitted to a third-party that generates the notifications.

2. The non-transitory computer-readable medium of claim 1 wherein said received information further comprises notification preferences set by the end user.

3. The non-transitory computer-readable medium of claim 1 further comprising proactively sending alerts to the end user of one or more events relevant to the end user and automatically scheduling the one or more event and associated reminders on the end user's device.

4. The non-transitory computer-readable medium of claim 1 wherein said notifications are drug test or alcohol test notifications, where the end user can select custom notification text messages to alert them when to test.

5. The non-transitory computer-readable medium of claim 1 wherein said GUI is configured for use on a mobile phone, tablet, laptop or desktop computer of the end user.

6. The non-transitory computer-readable medium of claim 1 wherein said app is configured to allow the end user device to be connected to one or more testing devices.

7. The non-transitory computer-readable medium of claim 1 further compromising an archive function for storing one or more sets of test verification data for documenting a testing history of the end user.

8. The non-transitory computer-readable medium of claim 1 further comprising a log that is created with each notification that the end user receives, where the log is evidence of whether or not the end user actually received notification of an event; and
wherein the log is stored and viewable on the end user's device and cannot be altered by the end user.

9. The non-transitory computer-readable medium of claim 1 wherein said notifications are voice notifications available in multiple languages, or tactile reminders through vibration of the end user device.

10. The non-transitory computer-readable medium of claim 1 wherein the third-party affiliated with the app has access to a separate web based administrator panel for setting the time and date of a test or event, where the end user receives a notification of test or event through a push notification.

11. The non-transitory computer-readable medium of claim 10 wherein the web based administrator panel generates a pass/fail scannable alphanumeric code for the end user, which the end user scans with their device and automatically transmits the results to a concerned party of interest.

12. The non-transitory computer-readable medium of claim 1 wherein said app further comprises an electronic wallet for check in to a testing center.

13. The non-transitory computer-readable medium of claim 1 wherein said app a photo function for the end user to take a time and date stamped photo of a receipt received from a test, the photo being saved to a photo gallery of said app.

14. The non-transitory computer-readable medium of claim 1 wherein said app further comprises a geo-location tagging function.

15. The non-transitory computer-readable medium of claim 1 wherein said platform randomly generates a daily alphanumeric code for the testing center or reporting location that is scanned by the end user with their device to prove attendance at the testing center or reporting location.

16. The non-transitory computer-readable medium of claim 1 wherein said app is configured to work with one or more of global positioning satellites (GPS), cellular system triangulation, internet protocol address (IP) to locate the closest testing site or reporting location with respect to the end user's current location.

17. The non-transitory computer-readable medium of claim 1 wherein said app further comprises bio metric capabilities for secure identification of the end user.

18. The non-transitory computer-readable medium of claim I wherein said app uses encryption for information sent by the end user.

19. An automated method for implementing an automated compliance monitoring application to remind and monitor for compliance testing and reporting, said method comprising:
providing an application (app) for an end user device with a graphical user interface (GUI) from a platform;
receiving information about the end user and the end user's geographic location via said graphical user interface (GUI) from a user;
receiving the end user's selection of one of a testing center or reporting location; and
verifying the end user based on the received information; and
sending notifications to the end user; and
wherein personally identifiable and confidential information of the end user is stored on the end user device and is not transmitted to a third-party that generates the notifications.

20. A system for implementing an automated compliance monitoring application to remind and monitor for compliance testing and reporting, said system comprising:
a server connected via a network to end user devices for use by a series of end users;
a memory system in electrical communication with said server containing a machine readable medium having stored thereon one or more sequences of instructions which, when executed by a processor, cause a method to be carried out, the method comprising:
providing an application (app) for an end user device with a graphical user interface (GUI) from a platform;
receiving information about the end user and the end user's geographic location via said graphical user interface (GUI) from a user;
receiving the end user's selection of one of a testing center or reporting location; and
verifying the end user based on the received information; and
sending notifications to the end user; and
wherein personally identifiable and confidential information of the end user is stored on the end user device and is not transmitted to a third-party that generates the notifications.
